(19) United States
(12) Patent Application Publication
(10) Pub. No.: US 2006/0120568 A1
(43) Pub. Date: Jun. 8, 2006

(54) System and method for tracking individuals

(76) Inventors: Patrick J. McConville, Fort Lauderdale, FL (US); Orlando Rodriguez, Miami, FL (US); Timothy H. McMahon, Boynton Beach, FL (US); Lawrence J. Mandell, Plantation, FL (US); Philip B. Connell, Pompano Beach, FL (US)

Correspondence Address: FISH & RICHARDSON P.C., P.O. BOX 1022, MINNEAPOLIS, MN, 55440-1022, US

(21) Appl. No.: 11/005,531

(22) Filed: Dec. 6, 2004

(51) Int. Cl. G06K 9/00

(52) U.S. Cl. 382/115

(57) ABSTRACT

In one general aspect, biometric information and location information associated with the biometric information are received. An individual is identified based, at least in part, on the biometric information. The individual is verified to be at a predetermined location and a predetermined time based, at least in part, on the location information.

### TECHNICAL FIELD

This invention relates to tracking, and more particularly to a system and method for tracking activities of individuals.

### BACKGROUND

Individuals are typically tracked through conventional means such as emails, calls, and electronic and paper logs to indirectly determine the activities of the individual. Generally, such indirect tracking relies upon the tracked individual to follow reporting procedures (e.g., record activities in a log) and assumes that the individual accurately and honestly reports the necessary information. For example, an individual (e.g., social worker) may record in a file that the individual met with another person (e.g., a child in foster care) at a specific location and/or for a particular duration of time. As a result, supervisors must rely only on the record in the file to make management or care decisions about an individual, monitor performance of the individual, and ensure that an entity (e.g., a social agency) is performing appropriate functions. In addition, when tracking is performed manually, there are typically delays between the time an activity is performed and an update to the file or other record, precluding supervisors from being able to effectively monitor the daily activities of their subordinates.

### SUMMARY

In one general aspect, biometric information and location information associated with the biometric information are received. An individual is identified based, at least in part, on the biometric information. The individual is verified to be at a predetermined location and a predetermined time based, at least in part, on the location information.

Implementations can include one or more of the following features. A time of entry or a time of exit from a vicinity may be determined based, at least in part, on associated location information. A second individual may be identified based on additional location information. Presence within a vicinity of a first individual and a second individual may be verified based, at least in part, on location information associated with each individual.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a tracking system;

FIG. 2 is a block diagram of a mobile tracking system; and

FIG. 3 illustrates a flow diagram for an example process for the tracking system of FIG. 1.

Like reference symbols in the various drawings indicate like elements.

### DETAILED DESCRIPTION

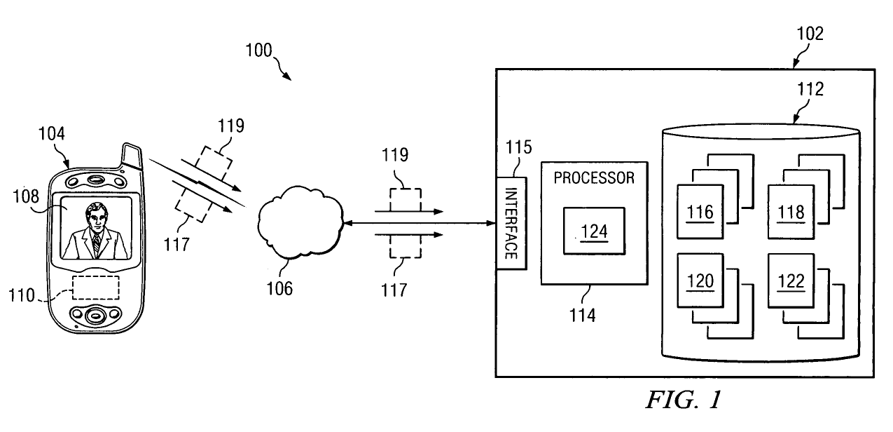

FIG. 1 is a block diagram for an electronic tracking system 100. At a high level, the system 100 operates in a distributed environment and verifies activities of an individual based, at least in part, on location information associated with an individual. Location information includes information that identifies or may be used to identify a location. For example, a location may include a longitude, a latitude, a time, a street address, a building location, a radial distance around a point, and/or any other suitable location. In the illustrated example, the system 100 includes a tracking server 102 connected to a biometric device 104 via a network 106. But the system 100 may be any other suitable computing environment. In general, the system 100 records and/or verifies activities of identified individuals. As a result, the system 100 facilitates the management of employees and/or care of individuals under the management of an organization.

The server 102 includes a memory 112 and a processor 114 and is generally an electronic computing device operable to receive, transmit, process, and store data associated with the system 100. For example, the server 102 may be any computer or processing device such as, for example, a blade server, general-purpose personal computer (PC), Macintosh, workstation, Unix-based computer, or any other suitable device. Generally, FIG. 1 provides merely one example of computers that may be used with the system 100. For example, although FIG. 1 illustrates one server 102 that may be used, the system 100 can be implemented using computers other than servers, as well as a server pool. In other words, the system 100 can include computers other than general-purpose computers as well as computers without conventional operating systems. As used in this document, the term “computer” encompasses a personal or handheld computer, workstation, network computer, or any other suitable processing device. The server 102 may be adapted to execute any operating system including Linux, UNIX, Windows Server, or any other suitable operating system.

The memory 112 may include any memory or database module and may take the form of volatile or non-volatile memory including, without limitation, magnetic media, optical media, random access memory (RAM), read-only memory (ROM), removable media, or any other suitable local or remote memory component. In this embodiment, the illustrated memory 112 includes biometric templates 116, demographic files 118, rulesets 120, and history files 122, but may also include any other appropriate data.

Each biometric template 116 defines parameters, variables, policies, algorithms, rules, instructions, and/or any other directive used by the server 102 to identify an individual based, at least in part, on biometric information received via the network 106. In one example, the biometric template 116 comprises biometric information such that the server 102 identifies an individual based, at least in part, on comparing a portion of the received biometric information to a portion of the biometric template 116. For example, the biometric template 116 may include biometric information of a child in foster care for identifying the child during meetings with a social worker. In this example, the biometric information may include a fingerprint, a retina pattern, an iris pattern, an image, hand geometry, or any other suitable information for identifying the child. The biometric template 116 may be any suitable format such as, for example, an eXtensible Markup Language (XML) document, a flat file, comma-separate-value (CSV) file, a name-value pair file, SQL table, an array, an object, or others. The biometric template 116 may be dynamically created by the server 102, by a third-party vendor, or any suitable user of the server 102, loaded from a default file, or received via the network 106. Furthermore, the biometric template 116 may be associated with one or more demographic files 118.

Each demographic file 118 includes one or more entries or data structures used by the server 102 to store or otherwise identify demographic information associated with an individual and are accessible by the processor 114. In one example, demographic information may include a name, an address, a telephone number, a birthday, emergency contact information, an image of an individual, and/or any other suitable information associated with an individual. Returning to the foster-child example, the demographic file 118 may include the child's name and birthday, foster-parent information, an image of the child, and/or any other information to facilitate the oversight of the child. Each demographic file 118 may be associated with a different individual, a group of individuals, or a plurality of demographic files 118 may be associated with a single individual. The demographic file 118 may be any suitable format such as, for example, an XML document, a flat file, CSV file, a name-value pair file, SQL table, or others. In one example, XML is used because it is easily portable, human-readable, and customizable. The demographic file 118 may be created by the server 102, a third-party vendor, any suitable user of the server 102, loaded from a default file, or received via the network 106. Furthermore, the demographic file 118 may be associated with one or more rulesets 120.

Each ruleset 120 includes rules, instructions, parameters, algorithms, and/or other directives used by the server 102 to verify activities of an individual. While the current description involves rules that describe activities expected of an individual, the rules may alternatively describe prohibited activities such that those activities violate the rule. The ruleset 120 may be associated with one or more biometric templates 116 and/or one or more demographic files 118 and, thus, an individual. In one example, the ruleset 120 includes, or otherwise identifies, a predetermined location and a predetermined time associated with an individual such that the server 102 may verify that the individual is at the location and time based, at least in part, on information received from the biometric device 104. In this example, a security guard may be required to inspect a series of predetermined locations at predetermined times in order to access security at those locations, and the ruleset 120 may verify these activities by requiring that he transmit his biometric and location information to server 102. In another example, the ruleset 120 includes, or otherwise identifies, two individuals such that the server 102 may verify that the two individuals meet based, at least in part, on information received from the biometric device 104. In this example, the ruleset 120 may additionally include, or otherwise identify, a duration, time, location, and/or vicinity such that the server 120 may verify that the two individuals meet for a predetermined duration or at a predetermined location and time based, at least in part, on information received from the biometric device 104. Again turning to the foster-child example, the ruleset 120 may require that an assigned social worker meet with the foster child for 30 minutes, and this meeting may be verified by transmitting the biometric and location information of both the foster child and/or the social worker. The ruleset 120 may define a vicinity such as, for example, a geographic perimeter, a vehicle, a vessel, a building, a portion of a building, a perimeter around a wireless device, and/or a perimeter around a different individual. In this case, the ruleset 120 includes directives for verifying that an individual or multiple individuals enter or exit a vicinity at a predetermined time, an individual or multiple individuals are present within a vicinity for a predetermined duration of time, and/or other activities occur. The ruleset 120 may be any suitable format such as, for example, an XML document, a flat file, CSV file, a name-value pair file, SQL table, or others. The ruleset 120 may be created by the server 102, a third-party vendor, any suitable user of the server 102, loaded from a default file, or received via the network 106. Additionally, the results based, at least in part, on the ruleset 120 may be stored in one or more history files 122.

Each history file 122 includes entries or data structures operable to identify activities associated with an individual. For example, the history file 122 may identify that an individual was at a location and time in accordance with an associated ruleset 120. In another example, the history file 122 may identify that two individuals met at a location and time as specified by the ruleset 120. In the foster-child example, the history file 122 may record activities involving an assigned social worker and the child and indicate whether those activities are in accordance with an associated ruleset 120. The history file 122 may include information received from the biometric device 104, the demographic files 118, the biometric templates 116, the rulesets 120, a combination of the forgoing, a process running on the server 102, the network 106, or the biometric device 104, or any other suitable source in the system 100. For example, the history file 122 may include, or otherwise identify, locations and times and images associated with one or more individuals. The history file 122 may be any suitable format such as, for example, an XML document, a flat file, CSV file, a name-value pair file, SQL table, or others.

The server 102 also includes the processor 114. The processor 114 executes instructions and manipulates data to perform the operations of the server 102 and may be any processing or computing component such as, for example, a central processing unit (CPU), a blade, an application specific integrated circuit (ASIC), or a field-programmable gate array (FPGA). Although FIG. 1 illustrates a single processor 114 in the server 102, multiple processors 114 may be used according to particular needs, and reference to the processor 114 is meant to include multiple processors 114 where applicable. The processor 114 executes the tracking engine 124, which identifies individuals based, at least in part, on incoming biometric information, correlates the identified individual with location information, identifies the rulesets 120 associated with the individual, and verifies activities of the individual based, at least in part, on the rulesets 120.

The tracking engine 124 could include any hardware, software, and/or firmware operable to receive biometric information, automatically identify an individual based, at least in part, on the received biometric information, and verify activities of the individual based, at least in part, on received location information. For example, the tracking engine 124 may be operable to compare received biometric information 117 with the biometric templates 116 for identifying an individual. Once identified, the tracking engine 124 may verify activities of the identified individual based, at least in part, on the rulesets 120 associated with the individual and the received location information 119. After the verification process, the tracking engine 124 may store the results in one or more history files 122 associated with the individual. Additionally, once the individual is identified, the tracking engine 124 may identify a demographic file 118 associated with the individual and transmit at least a portion of the demographic file to the biometric device 104. The tracking engine 124 may be written or described in any appropriate computer language including C, C++, Java, Visual Basic, assembler, any suitable version of 4GL, and/or others. It will be understood that while the tracking engine 124 is illustrated in FIG. 1 as a single multi-tasked module, the features and functionality performed by this engine may be performed by multiple modules such as, for example, an identification module, a verification module, and an access module. Further, while illustrated as internal to the server 102, one or more processes associated with the tracking engine 124 may be stored, referenced, or executed remotely. Moreover, the tracking engine 124 may be a child or sub-module of another software module (not illustrated).

The server 102 may also include an interface 115 for communicating with other computer systems, such as the biometric device 104, over the network 106 in a client-server or other distributed environment. For example, the server 102 often receives biometric information 117 and/or location information 119 from internal or external sources through the interface 115 for storage in the memory 112 and/or processing by the processor 114. Generally, the interface 115 comprises logic encoded in software and/or hardware in a suitable combination and operable to communicate with the network 106. More specifically, the interface 115 may comprise software supporting one or more communications protocols associated with communications the network 106 or hardware operable to communicate physical signals.

The network 106 facilitates wireless or wireline communication between the server 102 and the biometric device 104. Indeed, while illustrated as one network 106, the network 106 may be a plurality of communicably coupled networks 106, so long as at least portion of network 106 may facilitate communications between the biometric device 104 and the server 102. For example, the biometric device 104 may reside in a wireless or wireline intranet that is communicably coupled to the larger network, such as the Internet. In other words, the network 106 encompasses any internal or external network or networks, sub-network, or combination thereof operable to facilitate communications between various computing components in the system 100. The network 106 may communicate, for example, Internet Protocol (IP) packets, Frame Relay frames, Asynchronous Transfer Mode (ATM) cells, voice, video, data, and other suitable information between network addresses. The network 106 may include one or more local area networks (LANs), radio access networks (RANs), metropolitan area networks (MANs), wide area networks (WANs), all or a portion of the global computer network known as the Internet, and/or any other communication system or systems at one or more locations.

The biometric device 104 is any local or remote computing device operable to receive user commands, input, and/or queries through a graphical user interface (GUI) 108 and the biometric sensor 110. At a high level, each biometric device 104 includes at least the GUI 108, the biometric sensor 110, and an electronic computing device operable to receive, transmit, process, and store any appropriate data associated with the system 100. The biometric device 104 may include, reference, or execute Global Positioning System (GPS) systems, applications, or web services to supplement the input by the particular user. For example, a biometric device 104 may include a GPS component operable to determine, in near real time, the location of an individual associated with or a user of the biometric device 104. It will be understood that there may be any number of the biometric devices 104 (not illustrated) communicably coupled to the server 102. Further, “biometric device 104,” “individual,” and “user” may be used interchangeably as appropriate. Indeed, each user may have multiple devices 102, or in other cases, the device 102 may be used by a number of users. As used in this disclosure, the biometric device 104 encompasses a personal computer, touch screen terminal, workstation, network computer, kiosk, wireless data port, wireless or wireline phone, personal data assistant (PDA), one or more processors within these or other devices, or any other suitable processing device. For example, the illustrated biometric device 104 comprises a PDA, including global referencing capabilities (e.g., GPS). PDAs may be used as field input devices given their relative portability and wireless connectivity. In other words, biometric device 104 may be a computer that includes an input device, such as a keypad, touch screen, mouse, or other device that can accept information, and an output device that conveys information associated with the operation of the server 102 or the device 102, including digital data, visual information, or websites via a GUI 108. Both the input device and output device may include fixed or removable storage media such as a magnetic computer disk, CD-ROM, or other suitable media to both receive input from and provide output to users of the device 102 through the GUI 108, the biometric sensor 110, and the camera 110.

The GUI 108 is operable to allow the user of the biometric device 104 to interface with at least a portion of the system 100 for any suitable purpose. Generally, the GUI 108 provides the user of biometric device 104 with an efficient and user-friendly presentation of data provided by or communicated within the system 100. The GUI 108 may include customizable frames or views having interactive fields, pull-down lists, and buttons operated by the user. Moreover, reference to a graphical user interface includes multiple graphical user interfaces presented on a single display where appropriate. Therefore, the GUI 108 may be any graphical user interface, such as a generic web browser or touch screen that processes information in the system 100 and efficiently presents the results to the user. The server 102 can accept data from the biometric device 104 via the web browser (e.g., Microsoft Internet Explorer or Netscape Navigator) and return the appropriate HTML or XML responses using the network 106.

The biometric sensor 110 comprises any firmware, software, hardware, or combination thereof operable to measure, collect, gather, scan, determine, or otherwise identify biometric information associated with an individual. It will be understood that biometric information means, as used herein, any information operable to identify an individual based, at least in part, on the individuals physiological or behavioral features. For example, an individual's physiological features may include fingerprints, retina pattern, iris pattern, voice patterns, hand movements, facial patterns, and/or any other suitable physiological feature. An individual's behavioral features may include signature recognition, gait recognition, speaker recognition, typing recognition, and/or any other suitable physiological feature. The sensor 110 may be a camera or solid-state imaging device for collecting facial, retina, iris, or fingerprint data, a microphone for collecting voice data, a touch-sensitive pad for collecting signature or hand profile data, and/or any other suitable biometric sensor. In one example, sensor 110 also includes a keyboard associated with device 102 when typing recognition is used.

In one aspect of operation, the biometric device 104 identifies biometric information and location information associated with an individual. Regarding the foster-child example, biometric device 104 may measure or identify biometric information of the foster child and wirelessly transmit the biometric information and location information of the foster child. Once identified, the biometric device 104 may wirelessly transmit the information to the server 102 via the network 106. Alternatively or in combination, the biometric device 104 may store the information and upload the information to the server 102 at a later time. After receiving the information, the tracking engine 124 receives biometric information 117 and associated location information 119, and based, at least in part, on this information, the tracking engine 124 identifies an individual and associates the location information 119 with the individual. In the foster-child example, tracking engine 124 identifies the foster child and location engine 119 identifies a foster home based on the received information. For instance, the tracking engine 124 may compare the biometric information 117 with the biometric files 116. Once the tracking engine 124 determines that a portion of the biometric information 117 matches or otherwise identifies a portion of one or more of the biometric templates 116 associated with an individual, the tracking engine 124 associates the location information 119 with the individual. In response to the identification, the tracking engine 124 may identify the demographic files 118 associated with the individual and transmit demographic information to the biometric device 104 for processing or display. Additionally, the tracking engine 124 may identify associated rulesets 120 and verify activities of the individuals based, at least in part, on the associated rulesets 120. For example, the tracking engine 124 may verify that the individual is at a predetermined location at a particular time. In another example, the tracking engine 124 may identify two individuals and verify that the two individuals meet for a duration of time. After the verification process, the tracking engine 124 may store the results in the history files 122 associated the individual. Again turning to the foster-child example, the tracking engine 124 may verify that an assigned social worker met with the foster child for thirty minutes. Moreover, the tracking engine 124 may store additional information in associated history files 122 such as, for example, the biographic information 117, the location information 119, the demographic information from the demographic files 118, or any other suitable information associated with the individual.

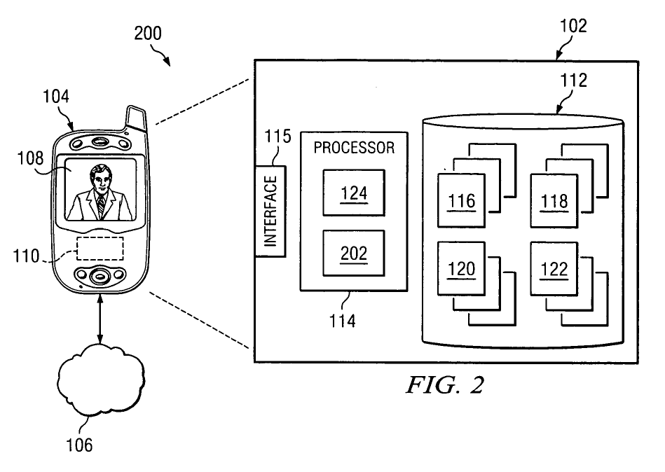

FIG. 2 illustrates a block diagram of a mobile tracking system 200. The mobile system 200 includes the features and functions of the tracking system 100 in a discrete mobile device, and thus, the elements with like numerals performs the same or analogous features and functions as detailed above in FIG. 1. Furthermore, the mobile device 200 includes the location engine 202 for determining the location of the mobile system 200.

The location engine 202 provides location information of a mobile system 200 based, at least in part, on any suitable method. The location engine 202 may determine location information based, at least in part, on signals received from an external source. For example, the location engine 202 may receive three GPS signals and implement a triangulation algorithm to determine a longitude and latitude of the mobile device 200. In this example, a fourth GPS signal may be processed to determine an altitude of the mobile device 200. Alternatively or in combination, location information may be determined based on signals transmitted by the biometric sensor 104. Examples may include one or more of the following techniques for determining location information: triangulating based, at least in part, on signal strengths of cellular phone signals received by base stations, determining radial distance around an access point or base station based, at least in part, on signal strength, and/or any other suitable technique. In these examples, the location engine 202 receives a signal from an external source (e.g., base station, access point, etc.) identifying the location information. Regardless, the location information may be determined, requested, or otherwise identified in response to a selection by a user, periodically (e.g., 1 sec, 5, sec, 30 sec., 1 min., etc.), or otherwise. The location information and/or received signals used to determine the location information may be in any suitable format whether open format, proprietary format, or other. Moreover, it will be understood that there may be any number of sources and that each sources may each be any suitable computer or processing device, application, web service, or other module or component.

In one aspect of operation, in response to a selection from a user, the mobile system 200 determines biometric information associated with a user of the mobile system 200 and a longitude, latitude, and time of the mobile system 200. Once the biometric information is determined, the tracking engine 124 identifies an individual based, at least in part, on the biometric information and the biometric templates 116, and in response to the identification, the tracking engine 124 identifies the demographic files 118, the rulesets 120, and the history files 122 associated with the individual. In one example, the mobile system 200 displays an image via the GUI 108 of the individual based, at least in part, on one or more identified demographic files 118. In the foster-child example, an image of the child may be displayed on the mobile system to facilitate the social worker in identifying the child. After identifying one or more rulesets 120 associated with the identified individual, the tracking engine 124 verifies activities of the individual. As discussed above, tracking engine 124 may verify that the individual is at a predetermined location and time, the individual is at a predetermined location for a duration of time, two individuals met for a duration of time, or any other activity based, at least in part, on biometric and location information. Once verified, the tracking engine 124 may store the results or any other suitable information associated with the individual in one or more history files 122.

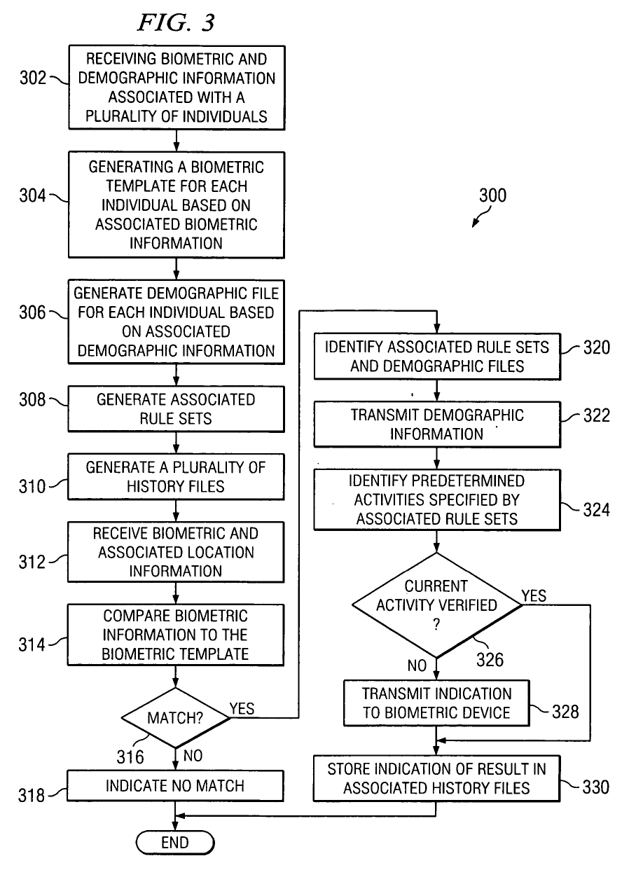

FIG. 3 illustrates a flow diagram implementing an example process for using the tracking system 100 of FIG. 1 to verify activities of an individual. Process 300 is described with respect to the tracking system 100 of FIG. 1, but process 300 could be used by any other application or applications. Moreover, the tracking system 100 may use any other suitable techniques for performing these tasks. Thus, many of the steps in this flowchart may take place simultaneously and/or in different orders as shown. Further, the tracking system 100 may execute logic implementing techniques similar to the process 300 in parallel or in sequence. The tracking system 100 may also use processes with additional steps, fewer steps, and/or different steps, so long as the process remain appropriate.

To begin with, two-high level steps for tracking individuals are executed: (1) generating biometric templates, demographic files, and rulesets; and (2) verifying activities of an identified individual. The process 300 begins at step 302 where biometric and demographic information associated with one or more individuals are received. Based, at least in part, on this information, at steps 304 and 306, one or more biometric templates and one or more demographic files are generated, respectively. Next, at step 308, one or more rulesets associated with each individual are generated. One or more history files associated with each individual are generated at step 310. Once biometric templates, demographic files, and rulesets have been generated, activities of an individual based, at least in part, on biometric and location information received from a biometric device are verified.

Turning to the verification process, biometric information and location information are received from a biometric device at step 312. Next, at step 314, the received biometric information is compared to biometric templates. If a match is not determined at decisional step 316, an indication that a match was not identified is transmitted to the biometric reader at step 318. If a match is determined at decisional step 316, then rulesets and demographic files associated with the identified individual are identified. At step 322, at least of portion of the demographic information identified by the demographic files is transmitted to the biometric device. Next, at step 324, predetermined activities specified by associated rulesets are identified. If current activities of the individual are not verified based, at least in part, on comparing the associated location information to rulesets at step 326, then an indication is transmitted to the biometric device that the current activities are not verified. In either case, an indication of the results is stored in associated history files.

Although this disclosure has been described in terms of certain embodiments and generally associated methods, alterations, and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method for tracking an individual, comprising:
receiving biometric information and location information associated with the biometric information;
identifying an individual based, at least in part, on the biometric information; and
verifying that the individual is at a predetermined location at a predetermined time based, at least in part, on the location information.

2. The method of claim 1, wherein the location comprises on of a longitude, a latitude, a time, a street address, a building location, a location within a building, a radial distance around an access point, or a combination of the forgoing.

3. A method for tracking an individual, comprising:
receiving initial biometric information and initial location information associated with the initial biometric information;
identifying a first individual based, at least in part, on the initial biometric information;
receiving additional biometric information and additional location information associated with the additional biometric information;
identifying a second individual based, at least in part, on the additional biometric information; and
verifying that the first individual and the second individual are present within a vicinity based, at least in part, on the initial location information and the additional location information.

4. The method of claim 3, wherein the vicinity comprises one of a geographic perimeter, a vehicle, a vessel, a building, a portion of a building, a perimeter around a wireless device, a perimeter around a different individual, and a combination of the foregoing.

5. The method of claim 3, further comprising identifying either a time of entry to or a time of exit from the vicinity based, at least in part, on associated location information.

6. The method of claim 3, wherein the individual is identified based, at least in part, on comparing the biometric information to a template associated with the individual, the template comprising stored biometric information associated with the individual.

7. The method of claim 3, wherein the biometric information was received from a biometric reader, further comprising:
identifying demographic information associated with the first individual in response to identifying the first individual; and
transmitting at least a portion of the demographic information to the biometric reader.

8. An article comprising a machine-readable medium storing instructions for causing data processing apparatus to perform operations comprising:
receiving initial biometric information and initial location information associated with the initial biometric information;
identifying a first individual based, at least in part, on the initial biometric information;
receiving additional biometric information and additional location information associated with the additional biometric information;
identifying a second individual based, at least in part, on the additional biometric information; and
verifying that the first and second individual are present within a vicinity based, at least in part, on the initial and additional location information.

9. The article of claim 8, wherein the vicinity comprises one of a geographic perimeter, a vehicle, a vessel, a building, a portion of a building, a perimeter around a wireless device, a perimeter around a different individual, and a combination of the foregoing.

10. The article of claim 8, further performing operations comprising identifying either a time of entry to or a time of exit from the vicinity based, at least in part, on associated location information.

11. The article of claim 8, wherein the individual is identified based, at least in part, on comparing the biometric information to a template associated with the individual, the template comprising biometric information associated with the individual.

12. The article of claim 8, wherein the biometric information was received from a biometric reader, further comprising:
identifying demographic information associated with the first individual in response to identifying the first individual; and
transmitting at least a portion of the demographic information to the biometric reader.

13. A mobile device for tracking individuals, comprising:
a location controller operable to receive wireless signals and determine location information based on the received wireless signals; and
a tracking controller operable to:
receive initial biometric information and initial location information associated with the initial biometric information;
receive additional biometric information and additional location information associated with the additional biometric information; and
store the initial biometric information, the initial location information, the additional biometric information, and the additional location information.

14. The mobile device of claim 13, the tracking controller further operable to:
identify a first individual based, at least in part, on the initial biometric information;
identify a second individual based, at least in part, on the additional biometric information; and
verify that the first and second individual are present within a vicinity based, at least in part, on the initial and additional location information.

15. The mobile device of claim 14, wherein the vicinity comprises one of a geographic perimeter, a vehicle, a vessel, a building, a portion of a building, a perimeter around a wireless device, a perimeter around a different individual, and a combination of the foregoing.

16. The mobile device of claim 14, the tracking controller further operable to identify either a time of entry to or a time of exit from the vicinity based, at least in part, on associated location information.

17. The mobile device of claim 14, wherein the individual is identified based, at least in part, on comparing the biometric information to a template associated with the individual, the template comprising biometric information associated with the individual.

18. The mobile device of claim 13, further comprising a transmitting controller operable to wirelessly transmit the initial biometric information, the initial location information, the additional biometric information, and the additional location information for remotely verifying activities of the first individual and the second individual.

19. An article comprising a machine-readable medium storing instructions for causing data processing apparatus to perform operations comprising:
receiving biometric information and location information associated with the biometric information;
identifying an individual based, at least in part, on the biometric information; and
verifying that the individual is a predetermined location and time based, at least in part, on the location information.

20. The article of claim 19, wherein the location comprises on of a longitude, a latitude, a time, a street address, a building location, a location within a building, a radial distance around an access point, or a combination of the forgoing.
